(19) United States
(12) Patent Application Publication
(10) Pub. No.: US 2026/0051447 A1
(43) Pub. Date: Feb. 19, 2026

(54) Contactor

(71) Applicants: Tyco Electronics (Shanghai) Co., Ltd., Shanghai (CN); Tyco Electronics Technology (SIP) Co., Ltd., Suzhou (CN)

(72) Inventors: Zesheng Jiang, Suzhou (CN); Quarry (Bingfeng) Qu, Suzhou (CN); Kevin (Xujia) Wang, Suzhou (CN); Wenpei Qin, Suzhou (CN); Lizhong Wang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/300,782

(22) Filed: Aug. 15, 2025

(30) Foreign Application Priority Data
Aug. 15, 2024 (CN) 202411124218.8

(51) Int. Cl. H01H 50/02; H01H 50/14; H01H 50/38; H01H 50/54

(52) U.S. Cl. CPC H01H 50/02; H01H 50/14; H01H 50/38; H01H 50/54

(57) ABSTRACT

A contactor includes an upper insulation housing having an arc extinguishing chamber, a movable terminal movably disposed in the arc extinguishing chamber, a pair of static terminals located above the movable terminal and fixed to the upper insulation housing, an insulation bracket installed in the arc extinguishing chamber, an upper magnetic conductor fixed between the upper insulation housing and the insulation bracket, and a lower magnetic conductor assembled onto the movable terminal to move synchronously with the movable terminal. The movable terminal is movable along a vertical direction between an open position electrically separated from the pair of static terminals and a closed position electrically in contact with the pair of static terminals, and in the closed position, there is a predetermined gap between the upper magnetic conductor and the lower magnetic conductor to prevent the upper magnetic conductor from colliding with the lower magnetic conductor.

### CROSS-REFERENCE TO RELATED APPLICATION

This application claims the benefit of the filing date under 35 U.S.C. § 119 (a)-(d) of Chinese Patent Application No. 202411124218.8, filed on Aug. 15, 2024.

### FIELD OF THE INVENTION

The present invention relates to a contactor.

### BACKGROUND OF THE INVENTION

When the coil of a contactor is energized, a main contact of the contactor is in a closed state, which can effectively connect and carry current. When the coil of the contactor loses power, the main contact of the contactor is in an open state, which disconnects the current. When a high-voltage circuit connected to the contactor is working normally, the current carried by the main contact of the contactor is relatively stable and normal. However, when abnormal conditions such as short circuits occur in the high-voltage circuit, the abnormal current will have a certain impact on the load-bearing capacity and stability of the main contact of the contactor.

High voltage direct current contactors are key devices in many electrical equipment, such as the electrical system of new energy vehicles. When surge currents occur between the movable and static contacts, the contactors will fail, causing unforeseeable and serious consequences. At the same time, the future development trend of new energy vehicles is high current and high voltage. When the high-voltage system fails, the surge current will reach 5 kA or even 15 kA or more. When such a large current flows through the movable and static contacts, strong electrical repulsion (including Lorentz force and Holm force) will be generated in the main contact circuit. The direction of this electrical repulsion is opposite to the contact direction between the movable and static contacts, which will cause them to open and lead to mis-operation.

In order to resist the aforementioned electric repulsion, upper and lower magnetic conductors are usually installed in the contactor. The upper magnetic conductor is mounted on a movable bracket inside the contactor and can move together with the movable bracket. The lower magnetic conductor is assembled onto the movable terminal of the contactor and can move together with the movable terminal. When a short circuit occurs in the high-voltage circuit connected to the contactor, the upper and lower magnetic conductors will be magnetized by the short-circuit current, allowing them to generate an attraction force towards the static contact on the movable contact. This attraction force can counteract the effect of the Holm force and improve the ability of the contactor to resist short-circuit current. However, the disadvantage of the existing solution is that the upper magnet conductor and the movable bracket move together, resulting in a heavier total weight of the movable parts, greater impact force, and lower impact resistance level. Under higher impact acceleration, it can cause the movable parts inside the contactor to malfunction, such as causing the contactor to be mistakenly closed.

### SUMMARY OF THE INVENTION

A contactor includes an upper insulation housing having an arc extinguishing chamber, a movable terminal movably disposed in the arc extinguishing chamber, a pair of static terminals located above the movable terminal and fixed to the upper insulation housing, an insulation bracket installed in the arc extinguishing chamber, an upper magnetic conductor fixed between the upper insulation housing and the insulation bracket, and a lower magnetic conductor assembled onto the movable terminal to move synchronously with the movable terminal. The movable terminal is movable along a vertical direction between an open position electrically separated from the pair of static terminals and a closed position electrically in contact with the pair of static terminals, and in the closed position, there is a predetermined gap between the upper magnetic conductor and the lower magnetic conductor to prevent the upper magnetic conductor from colliding with the lower magnetic conductor.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a contactor according to an exemplary embodiment of the present invention;

FIG. 2 shows a perspective sectional view of a contactor according to an exemplary embodiment of the present invention;

FIG. 3 shows another perspective sectional view of a contactor according to an exemplary embodiment of the present invention;

FIG. 4 shows a plan sectional view of a contactor according to an exemplary embodiment of the present invention, in which the movable terminal is in an open position electrically separated from the static terminal;

FIG. 5 shows a plan sectional view of a contactor according to an exemplary embodiment of the present invention, in which the movable terminal is in a closed position in electrical contact with the static terminal;

FIG. 6 shows another plan sectional view of a contactor according to an exemplary embodiment of the present invention, in which the movable terminal is in a closed position in electrical contact with the static terminal;

FIG. 7 shows an illustrative perspective view of a contactor according to another exemplary embodiment of the present invention when viewed from one side;

FIG. 8 shows an illustrative perspective view of a contactor according to another exemplary embodiment of the present invention when viewed from the other side;

FIG. 9 shows an illustrative perspective view of a contactor according to another exemplary embodiment of the present invention, wherein the upper insulation housing is not shown;

FIG. 10 shows a plan sectional view of a contactor according to another exemplary embodiment of the present invention; and

FIG. 11 shows an illustrative plan view of a contactor according to another exemplary embodiment of the present invention, wherein the upper insulation housing is not shown.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

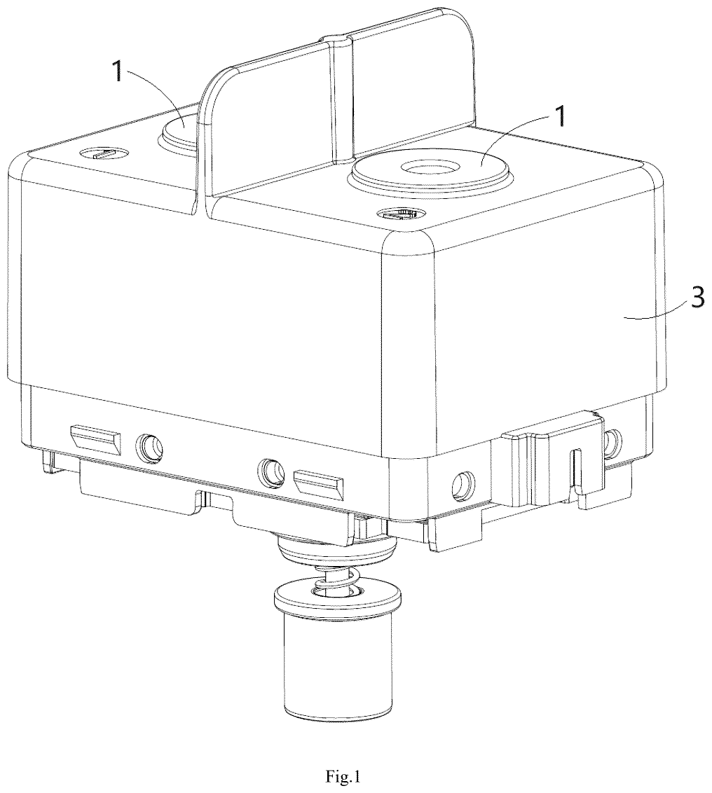

As shown in FIGS. 1 to 6, in an exemplary embodiment of the present invention, a contactor is disclosed. The contactor includes a pair of static terminals 1, a movable terminal 2, an upper insulation housing 3, an upper magnetic conductor 4, a lower magnetic conductor 5, and an insulation bracket 6. An arc extinguishing chamber 30 is formed in the upper insulation housing 3. The movable terminal 2 is set in the arc extinguishing chamber 30 of the upper insulation housing 3 in a movable manner. A pair of static terminals 1 are located above the movable terminal 2 and are fixed to the upper insulation housing 3. The insulation bracket 6 is installed in the arc extinguishing chamber 30 of the upper insulation housing 3. The upper magnetic conductor 4 is fixed between the upper insulation housing 3 and the insulation bracket 6, so that the upper magnetic conductor 4 is stationary relative to the upper insulation housing 3. The lower magnetic conductor 5 is assembled onto the movable terminal 2 to move synchronously with the movable terminal 2.

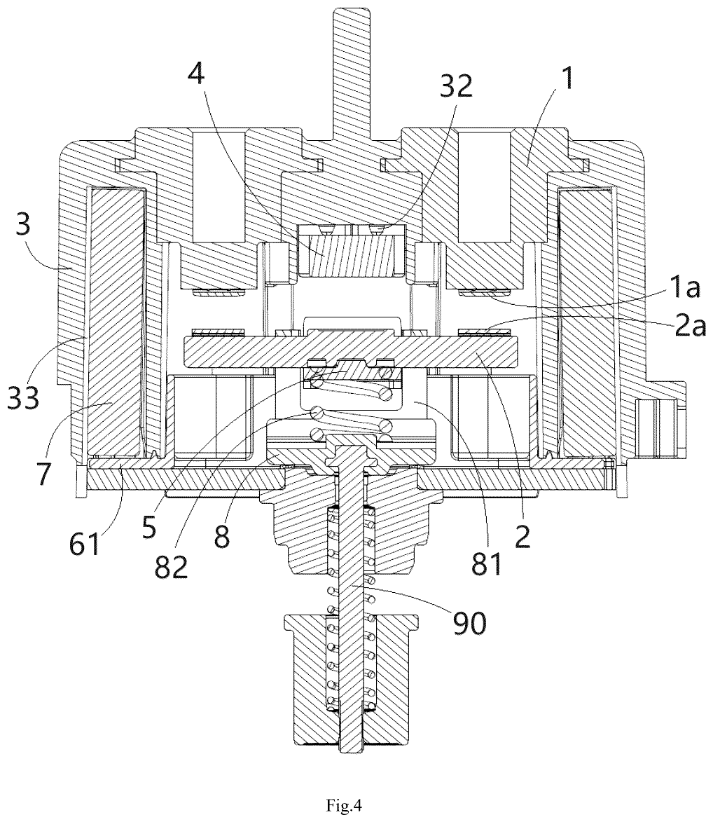

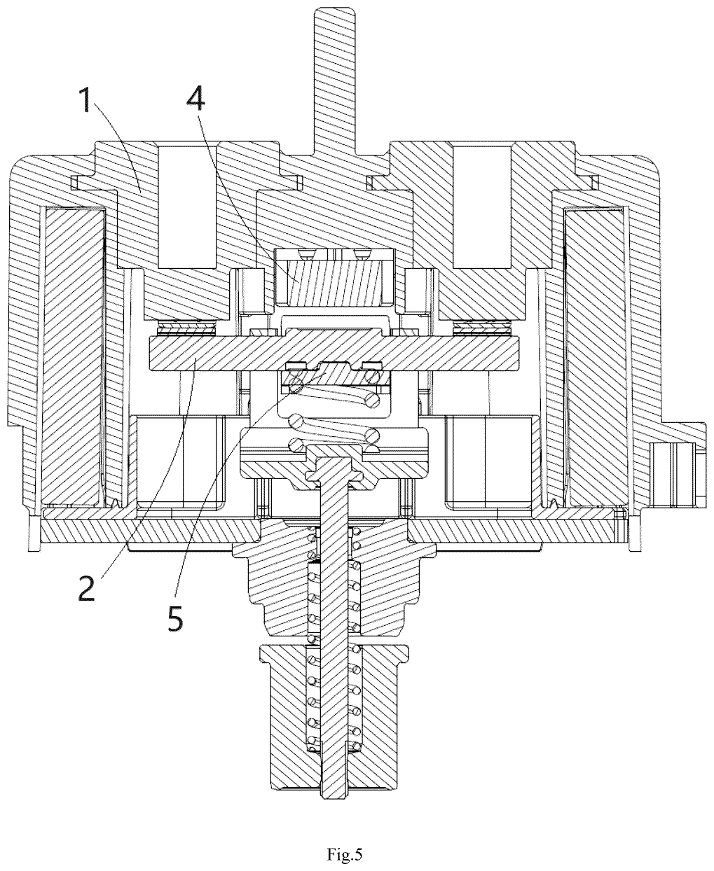

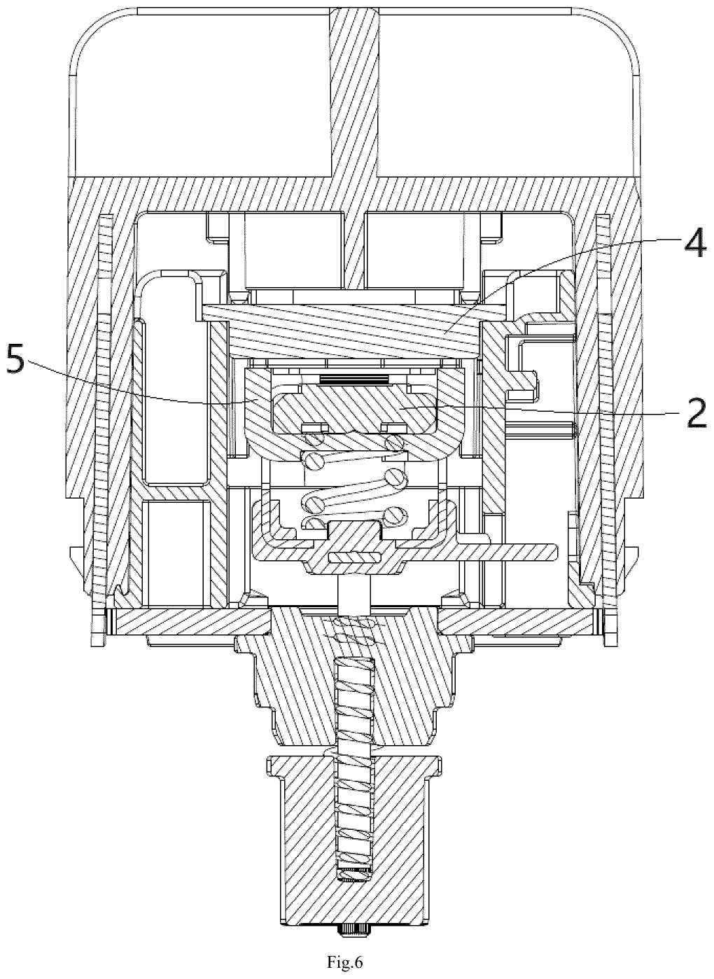

The movable terminal 2 can be moved in a vertical direction between an open position, shown in FIG. 4, electrically separated from the pair of static terminals 1 and a closed position, shown in FIGS. 5 and 6, electrically in contact with the pair of static terminals 1. When the movable terminal 2 is moved to the closed position, there is a predetermined gap between the upper magnet conductor 4 and the lower magnet conductor 5 to prevent the upper magnet conductor 4 from colliding with the lower magnet conductor 5.

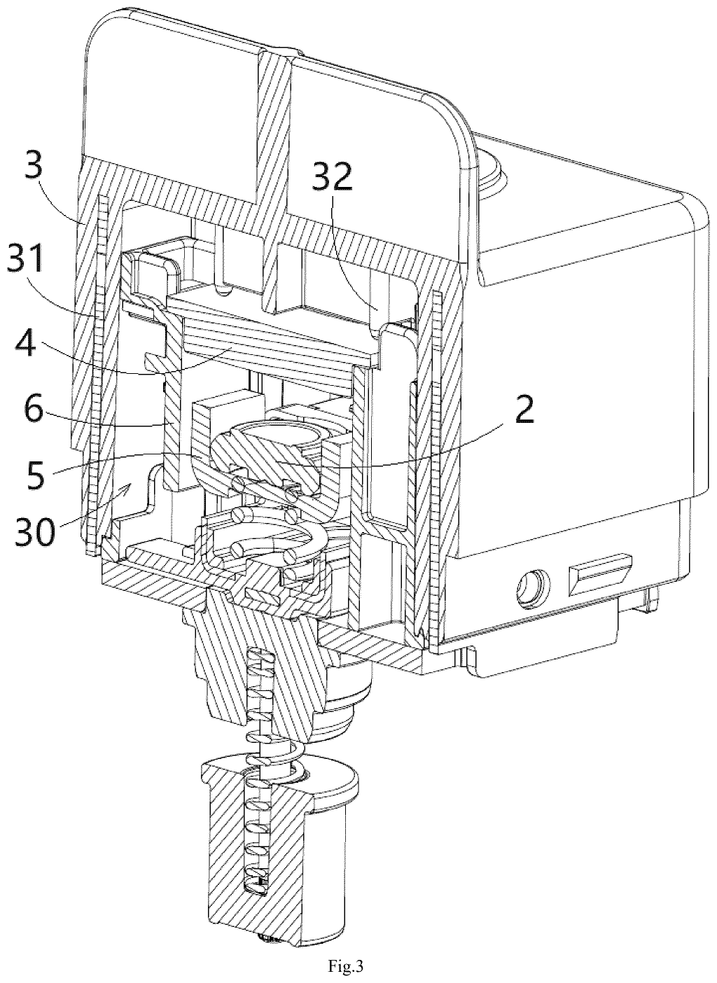

As shown in FIG. 3, in the illustrated embodiment, a positioning recess is formed on the top of the insulation bracket 6, and a pressing protrusion 32 is formed on the inner side of the top wall of the upper insulation housing 3. The upper magnetic conductor 4 is positioned in the positioning recess of the insulation bracket 6, and the pressing protrusion 32 is pressed against the top surface of the upper magnetic conductor 4, so that the upper magnetic conductor 4 is fixed in a predetermined installation position.

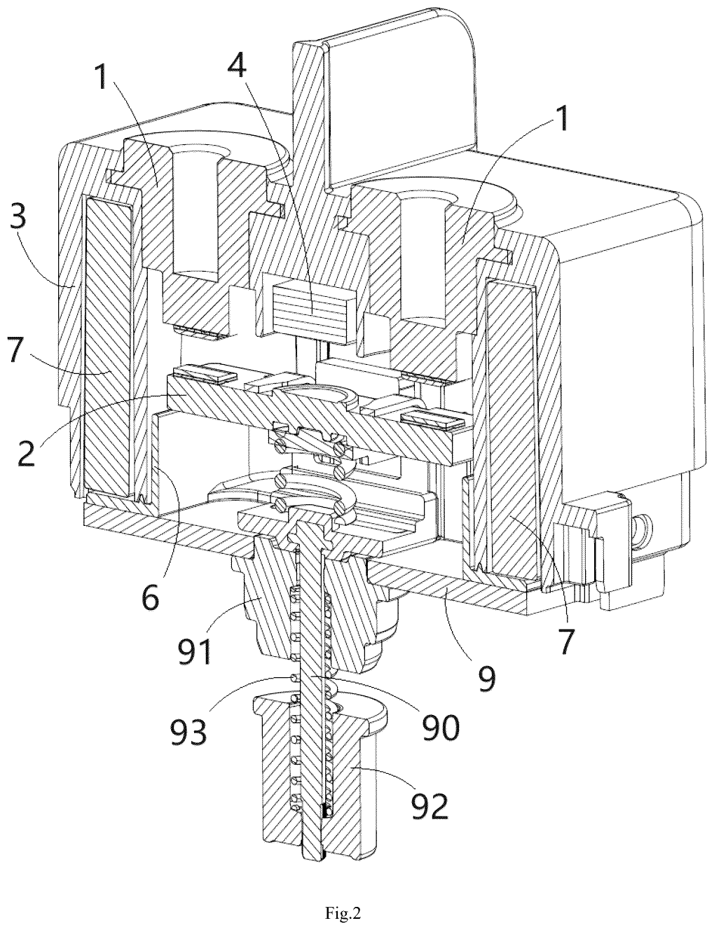

As shown in FIGS. 1 and 2, in the illustrated embodiment, the static terminal 1 has upper and lower ends that are opposite in the vertical direction. The upper end of the static terminal 1 is exposed from the top wall of the upper insulation housing 3 for electrical connection to an external high-voltage load circuit. The lower end of static terminal 1 extends into arc extinguishing chamber 30 for electrical contact with the movable terminal 2.

As shown in FIG. 4, in the illustrated embodiment, static contact points 1a are respectively formed on the bottom surfaces of the lower ends of a pair of static terminals 1, and movable contact points 2a are formed on the top surfaces of the two ends of the movable terminal 2. When the movable terminal 2 is moved to the closed position, shown in FIGS. 5 and 6, the movable contact points 2a at both ends of the movable terminal 2 make electrical contact with the static contact points 1a of the pair of static terminals 1.

As shown in FIG. 3, in the illustrated embodiment, the lower magnetic conductor 5 is U-shaped, the movable terminal 2 is assembled in the U-shaped groove of the lower magnetic conductor 5, and the upper magnetic conductor 4 is located above the top opening of the lower magnetic conductor 5.

As shown in FIGS. 2-4, in the illustrated embodiment, the contactor further comprises a pair of magnetic blowing magnets 7, which are respectively fixed in a pair of side walls of the upper insulation housing 3 and adjacent to the static contact points 1a of a pair of static terminals 1, respectively. The pair of magnetic blowing magnets 7 are suitable for extinguishing the arc between the movable terminal 2 and the static terminal 1 through magnetic blowing.

As shown in FIG. 4, in the illustrated embodiment, slots 33 are respectively formed in a pair of side walls of the upper insulation housing 3, and a pair of magnetic blowing magnets 7 are respectively inserted into the slots 33 in the pair of side walls. The slot 33 has an insertion port located on the bottom surface of the upper insulation housing 3, and the magnetic blowing magnet 7 is inserted into the slot 33 in the side wall through the insertion port.

As shown in FIG. 4, in the illustrated embodiment, the insulation bracket 6 includes a flange part 61 located at its bottom, which rests against the bottom surface of the magnetic blowing magnet 7 to hold the magnetic blowing magnet 7 in the slot 33.

As shown in FIGS. 3 and 4, in the illustrated embodiment, the contactor further comprises an upper shielding shell 31, which is arranged in the upper insulation housing 3 and surrounds the arc extinguishing chamber 30. The upper insulation housing 3 is directly molded onto the upper shielding shell 31 and the pair of static terminals 1 through embedded injection molding, so that the upper insulation housing 3, the upper shielding shell 31, and the pair of static terminals 1 are formed as a single piece.

In the illustrated embodiment, the contactor further comprises a lower insulation housing, a lower shielding shell, a coil assembly, and a magnetic conductive plate 9. The lower insulation housing is formed with a receiving chamber and its top is locked onto the bottom of the upper insulation housing 3. The lower shielding shell is set in the lower insulation housing and mated with the upper shielding shell 31. The coil assembly is installed in the receiving chamber of the lower insulation housing. The magnetic conductive plate 9 is supported on the top surface of the coil skeleton of the coil assembly. The flange part 61 of the insulation bracket 6 is clamped between the magnetic conductive plate 9 and the bottom surface of the upper insulation housing 3, so that the insulation bracket 6 is stationary relative to the upper insulation housing 3.

As shown in FIG. 4, in the illustrated embodiment, the contactor further comprises an insulation base 8, a contact spring 82, and a limit bracket 81. The insulation base 8 is located in the arc extinguishing chamber 30. The contact spring 82 is compressed between the lower magnetic conductor 5 and the insulation base 8 to apply contact pressure to the movable terminal 2. The limit bracket 81 is fixed to the insulation base 8 to restrict the direction and distance of movement of the movable terminal 2 relative to the insulation base 8.

As shown in FIGS. 2 and 4, in the illustrated embodiment, the contactor further comprises a drive shaft 90, which is arranged in the coil skeleton and its upper end passes through the magnetic conductive plate 9 and extends into the arc extinguishing chamber 30. The upper end of the drive shaft 90 is fixed to the insulation base 8, the insulation base 8 electrically isolates the upper end of the drive shaft 90 from the contact spring 82 and the limit bracket 81.

As shown in FIG. 4, in the illustrated embodiment, the insulation base 8 is directly molded onto the drive shaft 90 and the limit bracket 81 through embedded injection molding, so that the insulation base 8, drive shaft 90, and limit bracket 81 are formed as a single piece.

As shown in FIG. 2, in the illustrated embodiment, the contactor further comprises an upper magnetic core 91 and a lower magnetic core 92. The upper magnetic core 91 is located in the coil skeleton and fixed to the magnetic conductive plate 9. The lower magnetic core 92 is arranged in a movable manner in the coil skeleton and can move along its axial direction. The drive shaft 90 passes through the upper magnetic core 91 and the lower magnetic core 92, and the lower end of the drive shaft 90 is connected to the lower magnetic core 92 to move together with it.

As shown in FIG. 2, in the illustrated embodiment, the contactor further includes a reset spring 93, which is fitted on the drive shaft 90 and compressed between the upper magnetic core 91 and the lower magnetic core 92. When the coil of the coil assembly is energized, the drive shaft 90 drives the movable terminal 2 to move from the open position to the closed position under the action of electromagnetic force. When the coil of the coil assembly loses power, the drive shaft 90 drives the movable terminal 2 from the closed position to the open position under the elastic reset force of the reset spring 93.

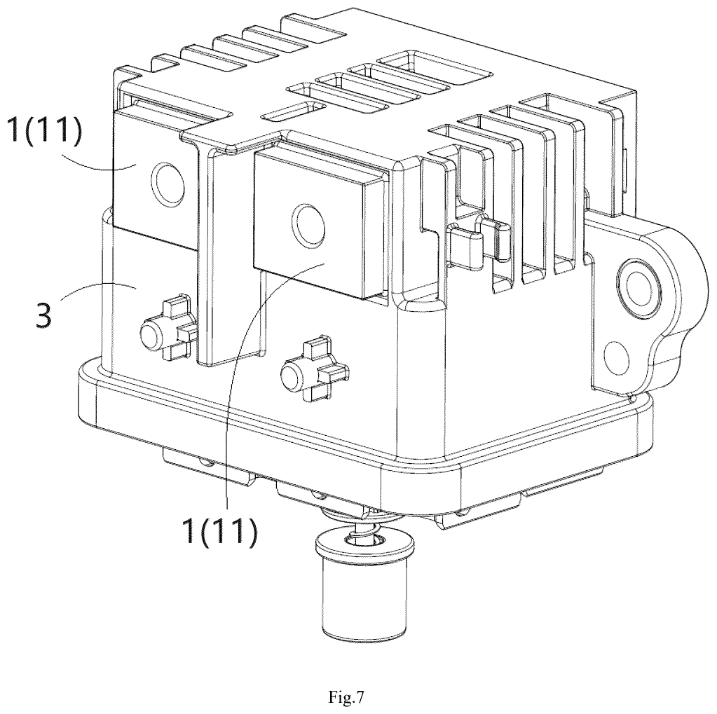

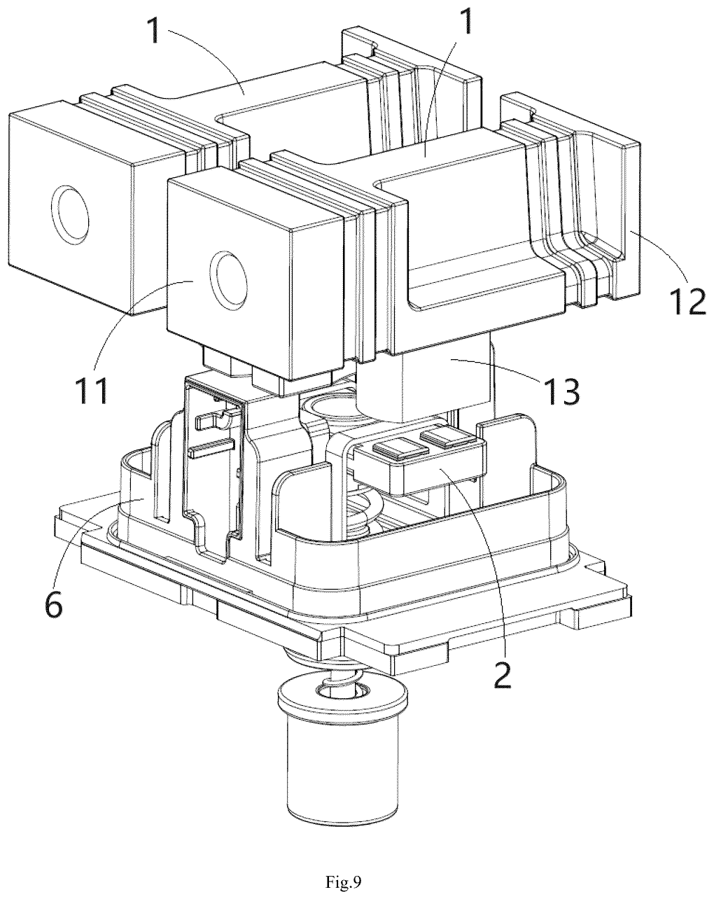

As shown in FIGS. 7-11, in another exemplary embodiment of the present invention, a contactor is disclosed. The main difference between the second embodiment shown in FIGS. 7-11 and the first embodiment shown in FIGS. 1-6 is the structure of the static terminal. Similar and identical technical features can be referred to in the first embodiment shown in FIGS. 1-6.

The contactor according to the embodiment of FIGS. 7-11 includes a pair of static terminals 1, a movable terminal 2, an upper insulation housing 3, an upper magnetic conductor 4, a lower magnetic conductor 5, and an insulation bracket 6. An arc extinguishing chamber 30 is formed in the upper insulation housing 3. The movable terminal 2 is set in the arc extinguishing chamber 30 of the upper insulation housing 3 in a movable manner. The pair of static terminals 1 are located above the movable terminal 2 and are fixed to the upper insulation housing 3. The insulation bracket 6 is installed in the arc extinguishing chamber 30 of the upper insulation housing 3. The upper magnetic conductor 4 is fixed between the upper insulation housing 3 and the insulation bracket 6, so that the upper magnetic conductor 4 is stationary relative to the upper insulation housing 3. The lower magnetic conductor 5 is assembled onto the movable terminal 2 to move synchronously with the movable terminal 2. The movable terminal 2 can be moved in the vertical direction between an open position electrically separated from the pair of static terminals 1 and a closed position electrically in contact with the pair of static terminals 1. When the movable terminal 2 is moved to the closed position, there is a predetermined gap between the upper magnet conductor 4 and the lower magnet conductor 5 to prevent the upper magnet conductor 4 from colliding with the lower magnet conductor 5.

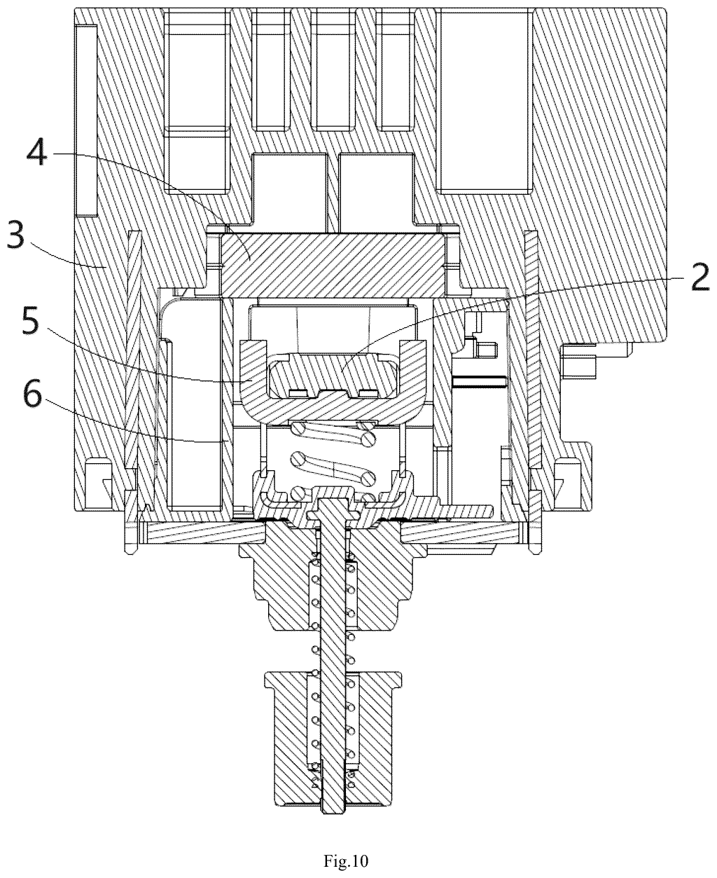

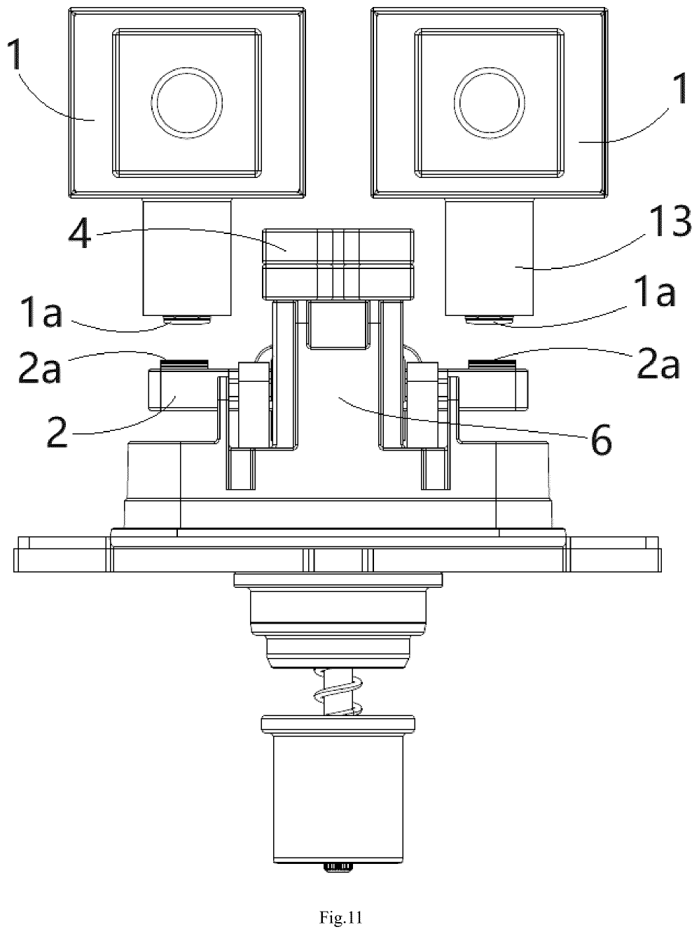

As shown in FIG. 10, in the illustrated embodiment, a positioning recess is formed on the inner side of the top wall of the upper insulation housing 3, and the upper magnetic conductor 4 is positioned in the positioning recess. The top of the insulation bracket 6 is pressed against the bottom surface of the upper magnetic conductor 4, as shown in FIG. 11, so that the upper magnetic conductor 4 is fixed in a predetermined installation position.

As shown in FIGS. 7-9, in the illustrated embodiment, the static terminal 1 has a first end 11 and a second end 12 that are opposite in the horizontal direction, and a post 13 located between the first end 11 and the second end 12. The first end 11 of the static terminal 1 is exposed from one side wall of the upper insulation housing 3 for electrical connection to an external high-voltage load circuit. The post 13 of the static terminal 1 extends into the arc extinguishing chamber 30 for electrical contact with the movable terminal 2.

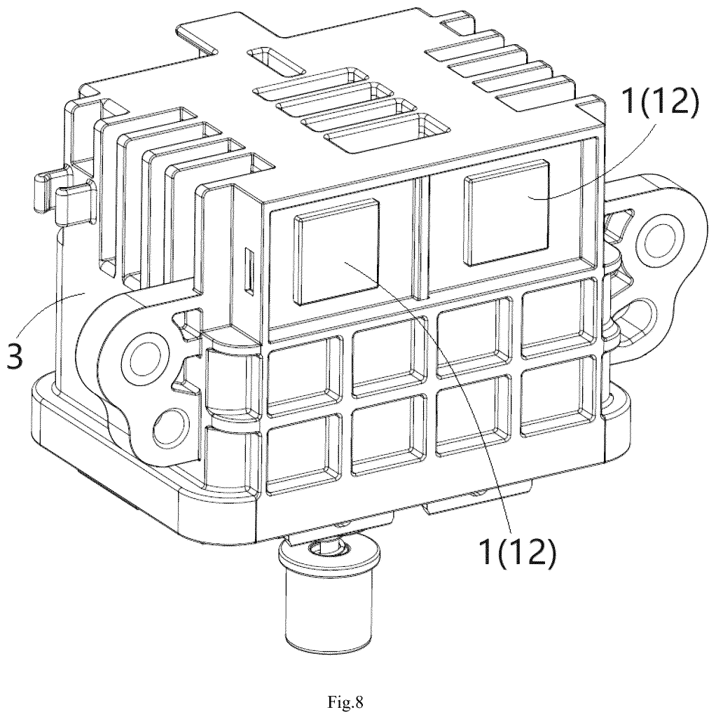

As shown in FIG. 8, in the illustrated embodiment, the second end 12 of the static terminal 1 is exposed from the other side wall of the upper insulation housing 3 for thermal connection to an external cooling circuit, so as to be able to cool the contactor through the external cooling circuit and the static terminal 1.

As shown in FIG. 11, in the illustrated embodiment, static contact points 1a are respectively formed on the bottom surfaces of the posts 13 of a pair of static terminals 1, and movable contact points 2a are respectively formed on the top surfaces of the two ends of the movable terminal 2. When the movable terminal 2 is moved to the closed position, the movable contact points 2a at both ends of the movable terminal 2 make electrical contact with the static contact points 1a of the pair of static terminals 1.

As shown in FIG. 10, in the illustrated embodiment, the lower magnetic conductor 5 is U-shaped, the movable terminal 2 is assembled in the U-shaped groove of the lower magnetic conductor 5, and the upper magnetic conductor 4 is located above the top opening of the lower magnetic conductor 5.

In the illustrated embodiment, the contactor further comprises a pair of magnetic blowing magnets 7, which are respectively fixed in a pair of side walls of the upper insulation housing 3 and adjacent to the static contact points 1a of a pair of static terminals 1, respectively. The pair of magnetic blowing magnets 7 are suitable for extinguishing the arc between the movable terminal 2 and the static terminal 1 through magnetic blowing.

Slots 33, as shown in FIG. 4, are respectively formed in a pair of side walls of the upper insulation housing 3, and a pair of magnetic blowing magnets 7 are respectively inserted into the slots 33 in the pair of side walls. The slot 33 has an insertion port located on the bottom surface of the upper insulation housing 3, and the magnetic blowing magnet 7 is inserted into the slot 33 in the side wall through the insertion port.

The insulation bracket 6 includes a flange part 61 located at its bottom, which rests against the bottom surface of the magnetic blowing magnet 7 to hold the magnetic blowing magnet 7 in the slot 33.

The contactor further comprises an upper shielding shell 31, which is arranged in the upper insulation housing 3 and surrounds the arc extinguishing chamber 30. The upper insulation housing 3 is directly molded onto the upper shielding shell 31 and the pair of static terminals 1 through embedded injection molding, so that the upper insulation housing 3, the upper shielding shell 31, and the pair of static terminals 1 are formed as a single piece.

The contactor further comprises a lower insulation housing, a lower shielding shell, a coil assembly, and a magnetic conductive plate 9. The lower insulation housing is formed with a receiving chamber and its top is locked onto the bottom of the upper insulation housing 3. The lower shielding shell is set in the lower insulation housing and mated with the upper shielding shell 31. The coil assembly is installed in the receiving chamber of the lower insulation housing. The magnetic conductive plate 9 is supported on the top surface of the coil skeleton of the coil assembly. The flange part 61 of the insulation bracket 6 is clamped between the magnetic conductive plate 9 and the bottom surface of the upper insulation housing 3, so that the insulation bracket 6 is stationary relative to the upper insulation housing 3.

The contactor further comprises an insulation base 8, a contact spring 82, and a limit bracket 81. The insulation base 8 is located in the arc extinguishing chamber 30. The contact spring 82 is compressed between the lower magnetic conductor 5 and the insulation base 8 to apply contact pressure to the movable terminal 2. The limit bracket 81 is fixed to the insulation base 8 to restrict the direction and distance of movement of the movable terminal 2 relative to the insulation base 8.

The contactor further comprises a drive shaft 90, which is arranged in the coil skeleton and its upper end passes through the magnetic conductive plate 9 and extends into the arc extinguishing chamber 30. The upper end of the drive shaft 90 is fixed to the insulation base 8. The insulation base 8 electrically isolates the upper end of the drive shaft 90 from the contact spring 82 and the limit bracket 81. The insulation base 8 is directly molded onto the drive shaft 90 and the limit bracket 81 through embedded injection molding, so that the insulation base 8, drive shaft 90, and limit bracket 81 are formed as a single piece.

The contactor further comprises an upper magnetic core 91 and a lower magnetic core 92. The upper magnetic core 91 is located in the coil skeleton and fixed to the magnetic conductive plate 9. The lower magnetic core 92 is arranged in a movable manner in the coil skeleton and can be moved along its axial direction. The drive shaft 90 passes through the upper magnetic core 91 and the lower magnetic core 92, and the lower end of the drive shaft 90 is connected to the lower magnetic core 92 to move together with it.

The contactor further includes a reset spring 93, which is fitted on the drive shaft 90 and compressed between the upper magnetic core 91 and the lower magnetic core 92. When the coil of the coil assembly is energized, the drive shaft 90 drives the movable terminal 2 to move from the open position to the closed position under the action of electromagnetic force; When the coil of the coil assembly loses power, the drive shaft 90 drives the movable terminal 2 from the closed position to the open position under the clastic reset force of the reset spring 93.

In the aforementioned exemplary embodiments according to the present invention, the upper magnetic conductor is fixed between the upper insulation housing and the insulation bracket without movement. In the present invention, the upper magnetic conductor is independently fixed, reducing the weight of the movable components, thereby reducing the large impact force caused by excessive weight and avoiding product mis-operation. Under the condition of a constant reset spring force, the present invention can effectively improve the impact resistance performance of the product without sacrificing the short-circuit resistance performance.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor, comprising:
an upper insulation housing having an arc extinguishing chamber;
a movable terminal movably disposed in the arc extinguishing chamber;
a pair of static terminals located above the movable terminal and fixed to the upper insulation housing;
an insulation bracket installed in the arc extinguishing chamber;
an upper magnetic conductor fixed between the upper insulation housing and the insulation bracket, the upper magnetic conductor is stationary relative to the upper insulation housing; and
a lower magnetic conductor assembled onto the movable terminal to move synchronously with the movable terminal, the movable terminal is movable along a vertical direction between an open position electrically separated from the pair of static terminals and a closed position electrically in contact with the pair of static terminals, and when the movable terminal is moved to the closed position, there is a predetermined gap between the upper magnetic conductor and the lower magnetic conductor to prevent the upper magnetic conductor from colliding with the lower magnetic conductor.

2. The contactor according to claim 1, wherein a positioning recess is formed on a top of the insulation bracket, and a pressing protrusion is formed on an inner side of a top wall of the upper insulation housing, the upper magnetic conductor is positioned in the positioning recess of the insulation bracket, the pressing protrusion is pressed against a top surface of the upper magnetic conductor, so that the upper magnetic conductor is fixed in a predetermined installation position.

3. The contactor according to claim 1, wherein a positioning recess is formed on an inner side of a top wall of the upper insulation housing, and the upper magnetic conductor is positioned in the positioning recess, a top of the insulation bracket is pressed against a bottom surface of the upper magnetic conductor, so that the upper magnetic conductor is fixed in a predetermined installation position.

4. The contactor according to claim 1, wherein the static terminals each have an upper end and a lower end opposite in the vertical direction, the upper end of the static terminal is exposed from a top wall of the upper insulation housing for electrical connection to an external high-voltage load circuit, the lower end of the static terminal extends into the arc extinguishing chamber for electrical contact with the movable terminal.

5. The contactor according to claim 4, wherein a pair of static contact points are respectively formed on a pair of bottom surfaces of the lower ends of the pair of static terminals, and a pair of movable contact points are respectively formed on a pair of top surfaces of a pair of ends of the movable terminal, and when the movable terminal is moved to the closed position, the movable contact points on the movable terminal electrically contact the static contact points of the pair of static terminals.

6. The contactor according to claim 1, wherein each of the static terminals has a first end and a second end that are opposite in a horizontal direction, and a post located between the first end and the second end, the first end of each of the static terminals is exposed from a side wall of the upper insulation housing for electrical connection to an external high-voltage load circuit, the post of each of the static terminals extends into the arc extinguishing chamber for electrical contact with the movable terminal.

7. The contactor according to claim 6, wherein the second end of each of the static terminals is exposed from another side wall of the upper insulation housing for thermal connection to an external cooling circuit, to cool the contactor through the external cooling circuit and the static terminals.

8. The contactor according to claim 7, wherein a pair of static contact points are respectively formed on a pair of bottom surfaces of the posts of the pair of static terminals, and a pair of movable contact points are respectively formed on a pair of top surfaces of a pair of ends of the movable terminal, and when the movable terminal is moved to the closed position, the movable contact points of the movable terminal electrically contact the static contact points of the pair of static terminals.

9. The contactor according to claim 1, wherein the lower magnetic conductor is U-shaped, and the movable terminal is assembled in a U-shaped groove of the lower magnetic conductor, the upper magnetic conductor is located above a top opening of the lower magnetic conductor.

10. The contactor according to claim 1, further comprising a pair of magnetic blowing magnets fixed in a pair of side walls of the upper insulation housing and adjacent to a pair of static contact points of the pair of static terminals, the pair of magnetic blowing magnets extinguish an electric arc between the movable terminal and the static terminals.

11. The contactor according to claim 10, wherein a pair of slots are respectively formed in a pair of side walls of the upper insulation housing, the pair of magnetic blowing magnets are respectively inserted into the slots in the pair of side walls, each of the slots has an insertion port located on a bottom surface of the upper insulation housing, the magnetic blowing magnets are inserted into the slots on the side walls through the insertion ports.

12. The contactor according to claim 11, wherein the insulation bracket has a flange part located at a bottom of the insulation bracket, the flange part is pressed against a bottom surface of each of the magnetic blowing magnets to hold the magnetic blowing magnets in the slots.

13. The contactor according to claim 12, further comprising an upper shielding shell provided in the upper insulation housing and surrounding the arc extinguishing chamber, the upper insulation housing is directly molded onto the upper shielding shell and the pair of static terminals through embedded injection molding, the upper insulation housing, the upper shielding shell, and the pair of static terminals are formed as a single piece.

14. The contactor according to claim 13, further comprising:
a lower insulation housing having a receiving chamber and a top locked onto a bottom of the upper insulation housing;
a lower shielding shell disposed in the lower insulation housing and mated with the upper shielding shell;
a coil assembly which is installed in the receiving chamber of the lower insulation housing; and
a magnetic conductive plate supported on a top surface of a coil skeleton of the coil assembly, the flange part of the insulation bracket is clamped between the magnetic conductive plate and the bottom surface of the upper insulation housing, the insulation bracket is stationary relative to the upper insulation housing.

15. The contactor according to claim 14, further comprising:
an insulation base located in the arc extinguishing chamber;
a contact spring compressed between the lower magnetic conductor and the insulation base to apply contact pressure to the movable terminal; and
a limit bracket fixed to the insulation base to restrict a direction and a distance of movement of the movable terminal relative to the insulation base.

16. The contactor according to claim 15, further comprising a drive shaft installed in the coil skeleton and having an upper end passing through the magnetic conductive plate and extending into the arc extinguishing chamber, the upper end of the drive shaft is fixed to the insulation base, the insulation base electrically isolates the upper end of the drive shaft from the contact spring and the limit bracket.

17. The contactor according to claim 16, wherein the insulation base is directly molded onto the drive shaft and the limit bracket through embedded injection molding, the insulation base, the drive shaft, and the limit bracket are formed as a single piece.

18. The contactor according to claim 16, further comprising:
an upper magnetic core located in the coil skeleton and fixed to the magnetic conductive plate; and
a lower magnetic core movably disposed in the coil skeleton and movable along an axial direction, the drive shaft passes through the upper magnetic core and the lower magnetic core, a lower end of the drive shaft is connected to the lower magnetic core to move together with the lower magnetic core.

19. The contactor according to claim 18, further comprising a reset spring fitted onto the drive shaft and compressed between the upper magnetic core and the lower magnetic core.

20. The contactor according to claim 19, wherein, when a coil of the coil assembly is energized, the drive shaft drives the movable terminal to move from the open position to the closed position under electromagnetic force, and when the coil of the coil assembly is deenergized, the drive shaft drives the movable terminal from the closed position to the open position under an elastic reset force of the reset spring.
